(19) United States
(12) Patent Application Publication
(10) Pub. No.: US 2005/0148313 A1
(43) Pub. Date: Jul. 7, 2005

(54) Headset cord retainer

(76) Inventor: Bill Tsang Chun Chee, Kwai Fong (HK)

Correspondence Address: BOHAN, MATHERS & ASSOCIATES, LLC, PO BOX 17707, PORTLAND, ME, 04112-8707, US

(21) Appl. No.: 11/027,405

(22) Filed: Dec. 31, 2004

Related U.S. Application Data
(60) Provisional application No. 60/534,463, filed on Jan. 6, 2004.

(51) Int. Cl. H04M 1/00

(52) U.S. Cl. 455/347

(57) ABSTRACT

Cord retainer for retaining a headset cord for use with a small electronic device. The cord retainer allows the user to limit to a desired length the length of cord that is exposed when using the handheld device. The retainer is made of stiffly flexible material and is small and comfortable to hold in the hand. A split around the circumference of the retainer allows a portion of the retainer to be snapped open, providing access to a core body, around which the headset cords are wound. Cord pass-throughs are provided in the retainer, through which cords for earbuds and audio plug are pulled. The retainer is also suitable for use with a combination headset/control panel component. The control panel body is integrated into the retainer body such that the control panel body serves as the core body, with control buttons accessible on the outside of the cord retainer.

### BACKGROUND INFORMATION

1. Field of the Invention

The invention relates to the field of cord retainers. More particularly, the invention relates to a cord retainer that is used with headsets. More particularly still, the invention relates to a headset cord retainer that is used with handheld electronic devices.

2. Description of the Prior Art

Portable electronic devices are often provided with headsets having ear buds at one end and an audio plug at the other. Due to the nature of portable electronic devices, it is important that the headsets be lightweight and not cumbersome. Because of that, the cords are typically quite thin. The portable electronic devices are often held or carried some distance away from the user's head, such as in a pant or jacket pocket or attached to a belt. In order to allow a user to comfortably wear the headset while the device is carried in a pant pocket, the headset cords are typically approximately four feet in length from the ear buds to the plug. These thin headset cords often become tangled or caught on other objects, particularly when the distance between the headsets and the location of the device is significantly less than the length of the headset cord.

Cord retainers are known for storing headset cords. These retainers are usually round and the headset cord is wound around the retainer. Typically, the audio plug is placed up against the retainer body and the cord wrapped around the plug. This type of retainer is not practical for use with the electronic device, because the plug is not accessible. In other words, the headset cords must be unwound from the retainer before the plug can be connected with the device.

Some conventional headset cord retainers include an enclosed spool and an opening through which the headset cord is extracted. The user pulls on the headset cord to extract the desired length of exposed cord. A disadvantage of this type of retainer is that it lacks a mechanism that would selectively restrict the cord from being inadvertently extracted from the retainer beyond the desired length. Thus, if the cord gets caught on something or is pulled on, it will unwind from the retainer spool.

Not only is it an inconvenience for the user to continually have to readjust the length of the headset cord, the long thin cords dangling loosely from the person of the user also present a safety hazard. The cords catch easily on clothing or external objects and may cause the user to stumble or fall when moving the electronic device while connected.

What is needed, therefore, is a headset cord retainer that will neatly store the headset cord when the device is not in use and will allow the user to extract a desired length of cord at each end of the headset cord, i.e., at the end with the ear buds and the end with the audio plug, and so enable the user to comfortably use the ear buds, as well as plug the audio plug into the device. What is further needed is such a cord retainer that will prevent additional length of cord from being inadvertently extracted from the retainer and will protect the wound portion of the headset cord.

### BRIEF SUMMARY OF THE INVENTION

For the reasons cited above, it is an object of the present invention to provide a headset cord retainer that stores the headset cord when the device is not in use, yet allows the user to extract a desired length of each end of the headset cord in order to connect the audio plug to the device and comfortably wear the headset. It is a further object of the present invention to provide such a headset cord retainer that prevents additional length of headset cord from being inadvertently extracted from the retainer. It is a yet further object to provide such a headset cord retainer that protects the wound portion of the headset cord.

The objects of the invention are achieved by providing a headset cord retainer that encloses the wound portion of the headset cord and has apertures through which the audio plug end and the ear bud ends of the cord are extractable. The headset cord retainer according to the invention comprises a neat, slim, retainer outer body made substantially of a stiffly flexible material and an inner core around which the headset cord is wound. The outer body is split into a first enclosure and a second enclosure, and peripheral cord openings or slots are provided around the perimeter of one or both of the first and second enclosures. These peripheral cord pass-throughs are dimensioned to accommodate a cord and allow an ear bud end of the cord, with a desired length of cord, to extend outward from the retainer, available for use. The edge of the second enclosure snaps or folds down away from the edge of the first enclosure, thereby exposing the inner core and providing access to the headset cord that is wound around the core. In addition to the peripheral cord pass-throughs, a plug-end pass-through is formed at one or both ends of the first enclosure. The plug-end pass-through is dimensioned to accommodate the audio plug end of the headset cord, which is the thickness of two cords. The audio plug end of the headset cord extends through the plug-end pass-through, allowing the plug end to be connected to the device. The inner core is ideally oblong or rectangular in shape, rather than round, as this shape prevents the cord from inadvertently unwinding.

The headset cord retainer according to the invention is a versatile device that is suitable for retaining the cords of conventional headsets that are provided with many types of portable electronic devices, such as MP3 and CD players, portable radios, cell phones, PDAs, and electronic instruments, such as electronic keyboards, in other words, with any device that is used with portable headsets. With some portable electronic devices, a control panel is integrated into the headset, and the audio plug is adapted to include connector pins for the controls. The headset cord retainer according to the invention is also suitable for use with such combination control panel/headsets. Ideally, with such combination control panel/headsets, the cord is wound around the core such that the control panel is situated on the first enclosure, on the outside of the retainer body, and the cord from the combination control panel/headset is inserted through one of the plug-end pass-throughs on the first enclosure. The cord is then wound around the inner core and the ear buds brought outside the headset cord retainer through any one or two of the peripheral cord pass-throughs.

The invention further encompasses an embodiment that integrates a remote control with a control panel into the headset cord retainer. In this embodiment, the body of the control panel serves as the inner core of the cord retainer. The first and second enclosures of the retainer body are integrated into the control panel housing, such that the enclosures enclose four sides of the control panel. At least one side of the control panel is exposed along the top surface of the first enclosure and the control buttons are mounted in this exposed side of the control panel. In this way, the body of the control panel provides an oblong or rectangular surface around which to wind the headset cord, with the buttons accessible for use on the outside of the integrated remote control/headset cord retainer.

With all embodiments, when the electronic device is no longer in use, the user unplugs the audio plug from the device, snaps open the second enclosure, winds the extended ear-bud ends and the audio-plug end of the cord around the core, so that just the buds and the plug extend from the retainer, and snaps the second enclosure back into its usual, closed position. The cord is securely enclosed in the retainer.

The headset cord retainer of the present invention is suitable for retaining headset cords of headsets that are provided with the following devices: Apple iPOD, Samsung NAPSTER 20.0 GB Digital Audio Player, Dell DJ MP3 Music Player, Sony CLIE series PDA, PalmOne Tungsten T3, and Tapwave ZODIAC. This information is provided only to recite examples of conventional devices for which use of the headset cord retainer of the present invention is particularly well-suited; the information is not intended to limit in any way the suitability of the headset cord retainer for use with other known or currently unknown headsets.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is a perspective view of a first embodiment of the headset cord retainer according to the invention.

FIG. 2 is a top planar view of the headset cord retainer of FIG. 1, showing the peripheral cord pass-throughs and the plug-end pass-throughs in the first enclosure.

FIG. 3 is an illustration of the headset cord retainer of FIG. 1, without a cord, showing the second enclosure folded down away from the first enclosure, with the inner core exposed.

FIG. 4 is an illustration of the headset cord retainer of FIG. 1, showing a cord wrapped around the inner core of the retainer.

FIG. 5 is a perspective view of the headset cord retainer according to the invention, shown retaining the cord and control panel of a combination control panel/headset.

FIG. 6 is a side view of the headset cord retainer as shown in FIG. 5.

FIG. 7 is a second embodiment of the headset cord retainer according to the invention, with the retainer body and the control panel body integrated into a single device, and with the control panel body serving as the inner core.

FIG. 8 is a top planar view of the headset cord retainer shown in FIG. 7.

### DETAILED DESCRIPTION OF THE INVENTION

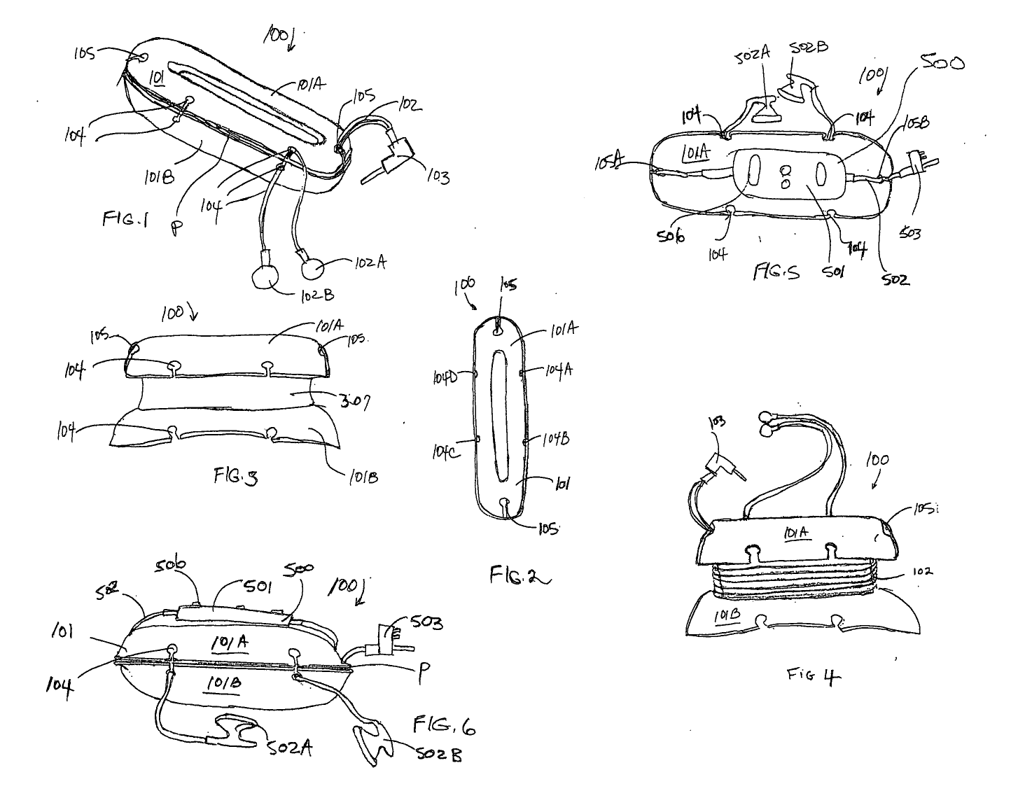

FIG. 1 is a perspective view of the first embodiment of a headset cord retainer 100 according to the invention comprising a retainer body 101. The retainer body 101 is a two-part enclosure with a first enclosure 101A and a second enclosure 101B, and a peripheral split P therebetween. One or more cord pass-throughs 104 are formed at the pheripheral split P of the first enclosure 101A. Also, a plug-end pass-through 105 is formed in the peripheral split P at each end of the first enclosure 101A. In the embodiment shown, one or more peripheral cord pass-throughs 104 are also formed in the peripheral split P in the second enclosure 101B. The peripheral cord pass-throughs 104 of the first and second enclosures 101A, 101B are shown in FIG. 1 as being just opposite each other on the retainer body 101. This is an illustration only of the placement of the peripheral cord pass-throughs 104 and is by no means limiting. A headset 102 having earbuds or earphones 102A, 102B and a plug 103 is shown together with the headset cord retainer 100. The cords of the earbuds are shown extending from two peripheral cord pass-throughs 104 and the plug 103 extending from one of the plug-end pass-throughs 105. In the embodiment shown, the peripheral cord pass-throughs 104 are dimensioned to accommodate the single cord attached to one of the earbuds 102A, 102B, and the plug-end pass-through 105 dimensioned to accommodate the double cord that attaches to the plug of a conventional headset.

FIG. 2 is a top planar view of the headset cord retainer 100, illustrating a suggested placement of peripheral cord pass-throughs 104A-D and the plug-end cord pass-throughs 105 on the first enclosure 101A.

FIG. 3 illustrates access to the inside of the retainer body 101, showing the second enclosure 101B folded down away from the first enclosure 101A, thereby exposing a core body 307. The core body 307 is oblong in shape, which reduces the likelihood that the cord will inadvertently unwind or be pulled from the core body 307. The headset cord retainer 100 is preferably made of a stiffly flexible rubber or rubber-like material that is pleasant to the touch and comfortable to hold in the hand. The second enclosure 101B is without the plug-end cord pass-throughs 105, so that, when it is folded down away from the first enclosure 101A, it will snap into an open position as shown, providing easy and comfortable access to the core body 307 around which the headset cord 102 is wound. To close the retainer 101, the user simply pushes the second enclosure 101B upward and the second enclosure 101B snaps into its closed position as shown in FIG. 1.

FIG. 4 illustrates the use of the headset cord retainer 100 with the headset cord 102. In this particular illustration, the cords for the earbuds are shown as extending from two different peripheral cord pass-throughs 104 on the same side of the retainer body 101. The cords may be pulled through any of the peripheral cord pass-throughs 104, depending on the preference of the user.

FIG. 5 is a planar view of the headset cord retainer 100 according to the invention, used to retain the cord of a conventional combination control panel/headset 500 having a control panel 501, headset 502 with earbuds 502A, 502B and a modified plug 503. Various control buttons 506 are provided on the control panel 501 as shown. The control panel 501 is positioned on the top of the first enclosure 101A. The plug-end of the cord is caught in a first plug-end cord pass-through 105B, and the cord from the other end of the control panel 501 fed through the plug-end cord pass-through 105A into the retainer body 101, where it is wound around the core body 307, with the desired length of cord for the earbuds 502A, 502B, being brought out through the selected peripheral cord pass-throughs 104. FIG. 6 is a side view of the headset cord retainer 100, showing the control panel 501 mounted on the outside of the retainer body 101.

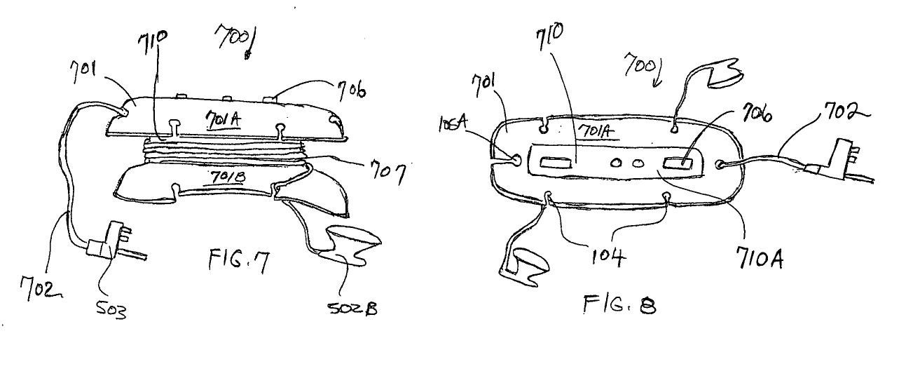

FIGS. 7 and 8 illustrate a second embodiment of the headset cord retainer 100, comprising a combination control panel/headset 700 having a headset 702, a retainer body 701. and a control panel body 710 that serves simulaneously as a core body 707 of the retainer body 701. The control panel body 710 is shaped similar to the core body 107 described above, and has a control panel face 710A with control buttons 706 at one end. The retainer body 701 has a first enclosure 701A and a second enclosure 701B, which are similar to the first and second enclosures 101A, 101B described above, but which are attached to the control panel body 710 so as to surround the core body 707 and provide user-access to the control panel face 710A. One end of the cords of the headset 702 is attached to the control panel 710. A user end of the headset 702 has a cord leading to the modified plug 503 and two other cords leading to the earbuds 502A, 502B. The cords of the headset 702 are wound around the control pane/core body 707 and the cord ends brought out through the peripheral cord pass-throughs 104 as shown in FIGS. 7 and 8.

It is understood that the embodiments described herein are merely illustrative of the present invention. Variations in the construction of the headset cord retainer may be contemplated by one skilled in the art without limiting the intended scope of the invention herein disclosed and as defined by the following claims.

1: A cord retainer for retaining a headset cord having an earphone and an audio plug, said cord retainer comprising a retainer body having a cord pass-through, said retainer body including a first enclosure and a second enclosure with a peripheral split therebetween, wherein said peripheral split is defined by a first peripheral edge of said first enclosure and a second peripheral edge of said second enclosure, and wherein said second enclosure is foldable away from said first enclosure so as to provide access to an inner cord-retaining space.

2: The cord retainer of claim 1, wherein a core body is assembled within said retainer body and that extends down through a central portion of said inner cord-retaining space to provide a surface around which said cord is windable.

3: The cord retainer of claim 2, wherein said core body has a length and a width and wherein said length is greater than said width.

4: The cord retainer of claim 1, wherein said cord pass-through includes an earphone-cord pass-through that is dimensioned to accommodate an earphone cord and a plug-cord pass-through that is dimensioned to accommodate a plug cord.

5: The cord retainer of claim 4, and wherein said earphone-cord pass-through and said plug-cord pass-through are formed in said first peripheral edge.

6: The cord retainer of claim 5, wherein said earphone-cord pass-through is formed in said second peripheral edge of said second enclosure.

7: The cord retainer of claim 5, wherein at least said second enclosure is made of an enclosure material that is stiffly flexible yet bendable such that said second peripheral edge of said second enclosure is foldable away from said peripheral split, allowing access to said cord-retaining space.

8: The cord retainer of claim 7, wherein said enclosure material is such that when said second peripheral edge is folded out and away from said peripheral split, said second enclosure snaps to an open position.

9: The cord retainer of claim 2, further comprising a control panel with a control panel body that is integrated into said retainer body, wherein said control panel body serves as said core body and has a control panel face that is exposed on an outer surface of said first enclosure so as to provide ready access to one or more control buttons provided on said control panel face.

10: A cord retainer for retaining a headset cord having an earphone and an audio plug, said cord retainer comprising:
a retainer body that includes a first enclosure, a second enclosure, and a peripheral split therebetween, wherein a first peripheral edge of said first enclosure and a second peripheral edge of said second enclosure define said peripheral split,
wherein a first plurality of earphone-cord pass-throughs are cut into said first peripheral edge and a second plurality of earphone-cord pass-throughs are cut into said second peripheral edge, said first and second pluralities of earphone-cord pass-throughs being dimensioned to accommodate a cord thickness of said cord attached to said earphone,
wherein a plug-cord pass-through is formed in said first peripheral edge, said plug pass-through being dimensioned to accommodate a plug thickness of said cord attached to said audio plug,
wherein said second enclosure is foldable away from said first enclosure so as to provide access to said an inner cord-retaining space, and wherein said cord pass-throughs are dimensioned to accommodate a thickness of said cord so as to allow said cord attached to said earphone to pass through a cord pass-through of said plurality of cord pass-throughs, enabling easy access to said earphone.
